(19) United States
(12) Patent Application Publication
(10) Pub. No.: US 2009/0167141 A1
(43) Pub. Date: Jul. 2, 2009

(54) Sealing structure of screw lamp

(76) Inventor: Tung-Ching Lee, Hsin Chu City (TW)

Correspondence Address: Tung-Ching Lee, P.O. Box 7-820, Taipei, TW

(21) Appl. No.: 12/005,982

(22) Filed: Dec. 31, 2007

(51) Int. Cl. H01J 5/48

(52) U.S. Cl. 313/318.08

(57) ABSTRACT

A sealing structure of lighting source of screw lamp, wherein the lighting element is provided in the opening of one end of the screw tube of the lamp, the lighting element is two conductive pins bridged with tungsten wire and a lighting element and discharge pipe are provided in the opening of the other end so that they can form an integrated structure through hot melt, flattening and fusion.

### BACKGROUND OF THE INVENTION

(a) Field of the Invention

The present invention is related to a sealing structure of screw lamp, wherein the one lighting element is provided in the opening of one end of the screw tube of the lamp; the lighting element is two conductive pins bridged with tungsten wire and a lighting element and discharge pipe are provided in the opening of the other end so that they can form an integrated structure through hot melt, flattening and fusion.

(b) Description of the Prior Art

The screw lamps presently exported to Europe and USA inherit the traditional structure whereby a horn column B is embedded in the opening of the glass light tube. As shown in FIG. 6, the circumference of the horn opening of the wick is integrated with the opening of the light tube by means of hot melt. However, the following shortcomings are identified in the horn column:
1) Complicated to manufacture and difficult to achieve a stable yield rate;
2) Difficult to be fused with the light tube, unnecessarily resulting in increased cost and defective rate of the lamp;
3) Restricts the downsizing of the opening of light tube when the lighting efficiency of the lamp is increasing day by day and the lamp tends to be more delicate and smaller sized.

Hence, the shortcomings in the structure of the screw lam are yet to be improved by the industry to be perfect and practical.

### SUMMARY OF THE INVENTION

The primary purpose of the present invention is to provide a sealing structure of screw lamp, wherein the horn column is replaced by a lighting element that is two conductive pins bridged with tungsten wire at the top to simplify the manufacturing process and downsize the lamp.

The secondary purpose of this invention is to provide a sealing structure of lighting source of screw lamp, wherein a lighting element is embedded in the opening of one end of the screw lamp and a lighting element and discharge pipe are provided in the opening of the other end so that they can form an integrated structure through hot melt, flattening and fusion to provide the function of simplifying the process of fully sealing the opening.

### BRIEF DESCRIPTION OF THE DRAWINGS

FIG. 1 is a drawing of a good embodiment of the present invention.

FIG. 2 is a 3D drawing of the components of the present invention.

FIG. 3 is a cross-section view of the components of the present invention.

FIG. 4 is a schematic view showing that the opening of the lamp is flattened, fused and sealed in the present invention.

FIG. 5 is a schematic view showing the embodiment of another ball-type conductive pin in the present invention.

FIG. 6 is a schematic view of the traditional structure of the present invention.

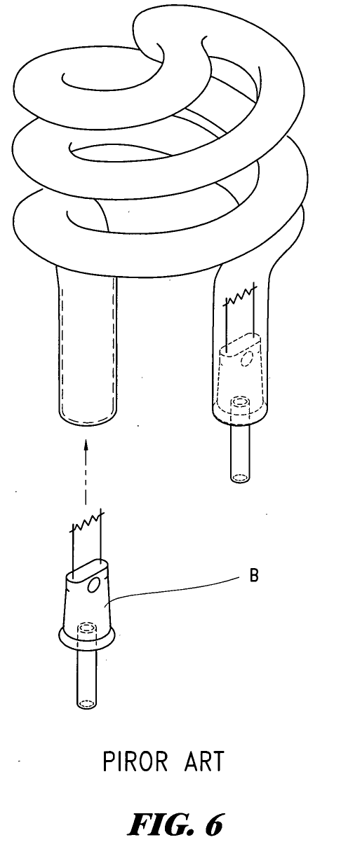

### DETAILED DESCRIPTION OF THE PREFERRED EMBODIMENTS

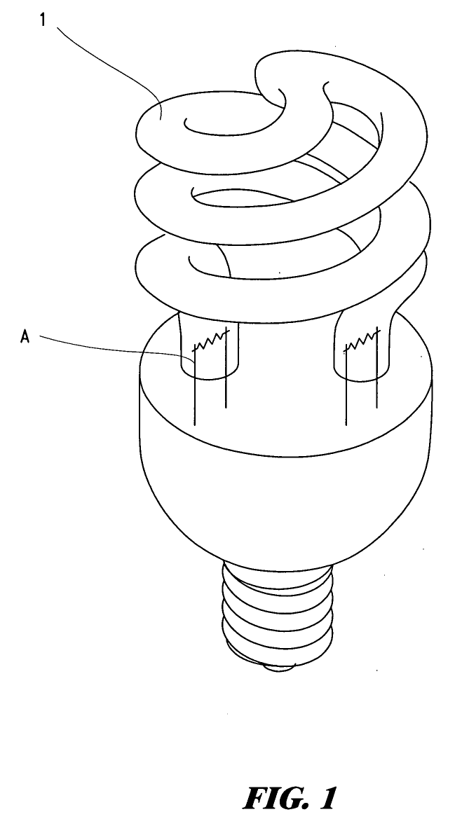

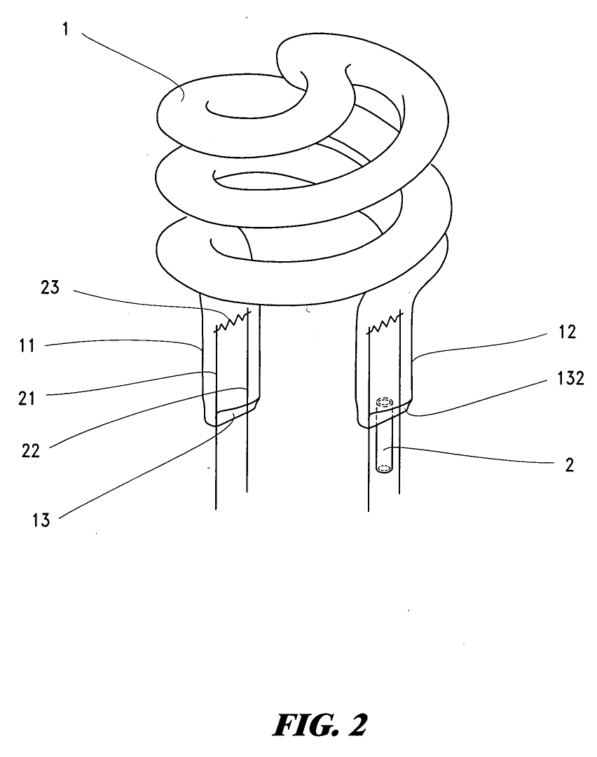

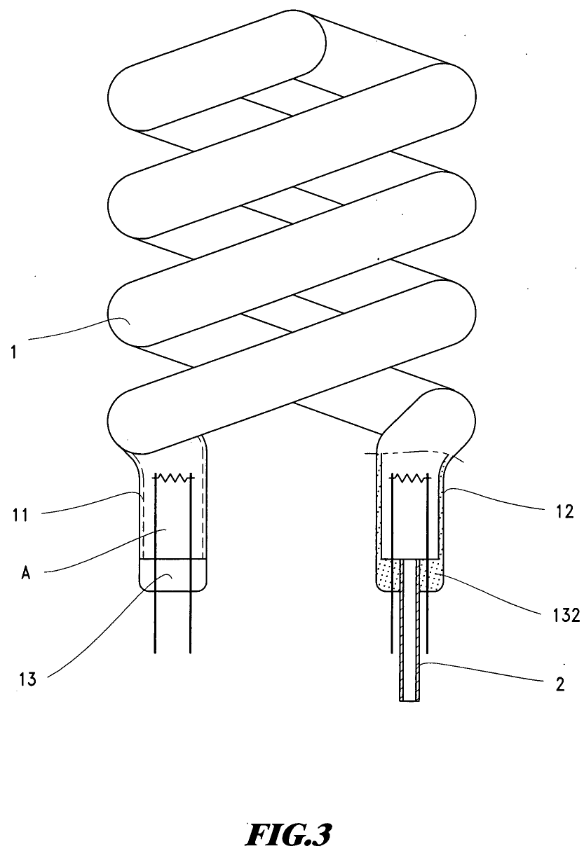

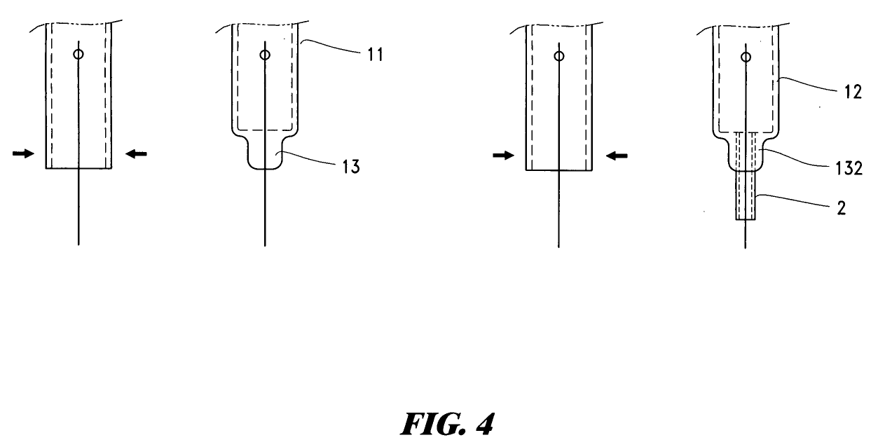

Referring to FIGS. 1 to 4, there is shown the present invention is related to a sealing structure of lighting source of screw lamp, wherein a lighting element A being embedded in the opening at one end of the lamp 11 of the screw light tube of the screw lamp 1 and the lighting element being 2 conductive pins 21, 22 being bridged with tungsten wire 23 at the top; a lighting element A and discharge pipe 3 are also embedded in the opening at the other end of the light tube 12 of the screw lamp 1 and the opening of the light tube 11, 12 are heated to be integrated with the lighting element A and discharge pipe 3 through hot melt, flattening and fusion to seal the openings 13, 132.

In one embodiment of this invention, the horn column B is replaced by a lighting element A to simplify the manufacturing process and seal the opening tightly to avoid leakage and the screw lamp can be fully miniatured due to the absence of restriction on the size of the traditional horn column, which is indeed a revolutionary breakthrough in the screw lamp technology.

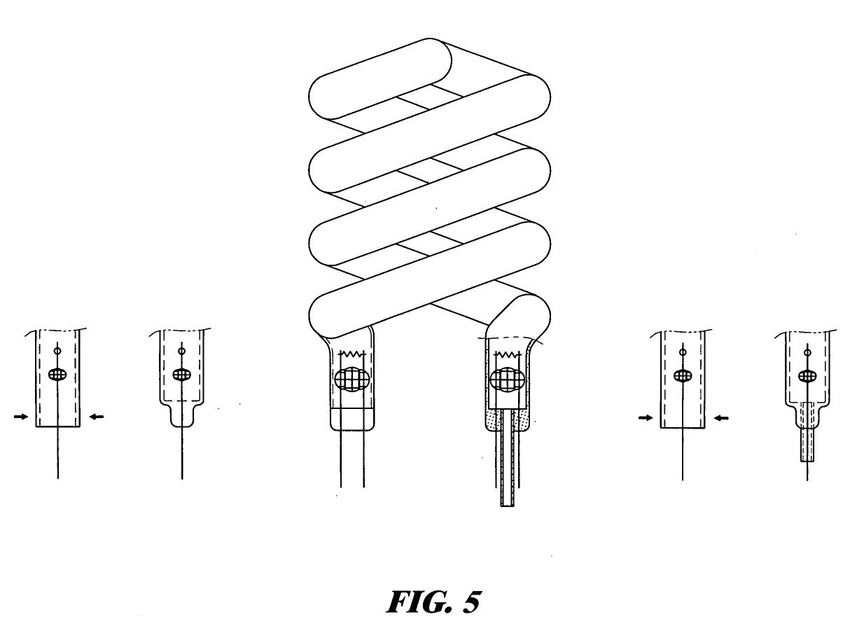

In another embodiment of this invention, as shown in FIG. 5, the lighting element A may also be two conductive pins bridged with Tungsten wires at the top and one glass ball 25 to provide a simplified process structure.

While certain novel features of this invention have been shown and described and are pointed out in the annexed claim, it is not intended to be limited to the details above, since it will be understood that various omissions, modifications, substitutions and changers in the forms and details of the device illustrated and in its operation can be made by those skilled in the art without departing in any way from the spirit of the present invention.

I claimed:

1. A sealing structure of lighting source of screw lamp, wherein the lighting element is provided in the opening of one end of the screw tube of the lamp, the lighting element is two conductive pins bridged with Tungsten wire and a lighting element and discharge pipe are provided in the opening of the other end so that they can form an integrated structure through hot melt, flattening and fusion.

2. A sealing structure of lighting source of screw lamp of claim 1, wherein the two conductive pins of the lighting element is provided with a glass ball.
